(19) United States
(12) Patent Application Publication
(10) Pub. No.: US 2023/0354872 A1
(43) Pub. Date: Nov. 9, 2023

(54) Cavity creation for uniformly heating pre-cooked and pre-processed food

(71) Applicant: Jitendra Raisinghani, Nashville, TN (US)

(72) Inventor: Jitendra Raisinghani, Nashville, TN (US)

(21) Appl. No.: 17/739,168

(22) Filed: May 9, 2022

(51) Int. Cl. A23P 20/20; A47J 36/16

(52) U.S. Cl. CPC A23P 20/20; A47J 36/16

(57) ABSTRACT

Embodiments disclose a utility model that pertains to pre-cooked and pre-processed food industry for food placement and packaging method to enable uniform heating of food by end customer. The method comprises of pushing an external object (insert piece device) into the food body to allow food to be pushed against the outer walls of the food container. Once desired proportion is achieved, the insert piece device is removed from the food body to form an open cavity in the food body. The cavity creates more open surface area of food exposed for better heat transfer and also reduces food thickness and removes the solid food fill that forms hard-to-heat cold pockets, so now when the food is heated by way of conduction, convection or radiation the heat transfer can reach the food to a greater degree to heat it uniformly and efficiently. The central cavity can be used to store variety of items comprising of food, health and personal items.

### FIELD OF THE INVENTION

Embodiments disclosed herein generally relate to methods, apparatus and systems for pre-cooked and pre-processed food heating and more particularly relates to a pre-cooked and pre-processed food placement and packaging method that creates a cavity within the food item that results in uniformly heating of the food contents by creating more open surface area of food exposed for better heat transfer and also reducing food thickness and removing the solid food fill that forms hard-to-heat cold pockets.

### DESCRIPTION OF THE RELATED ART

With more than one-third of the U.S. population over age 50 and maturing Millennials starting families or moving out on their own, it's not surprising that activities, including eating, are recentering around the home. Just over eight in 10 consumers prepare and eat their evening meal at home four or more nights per week (FMI 2017a). And 42% of shoppers say they do so more often than in 2016 (Packer 2017).

But despite an increased passion for cooking, especially among Millennials, time pressures and a desire for more sophisticated fare are forcing Americans to further outsource their meals. Nearly one-third (30%) of evening meals are now completely prepared outside of the home; 34% are made from a mix of prepared/partially prepared and some scratch items; and 35% are made from scratch (Hartman 2017). One in five food shoppers looks for meals that require little or no preparation (FMI 2017a).

Rising effects of COVID-19 are likely to contribute towards the growth of the pre-cooked and pre-processed food in the country on the back of increased consumer preference regarding hygiene concerns to contain the spread of the virus. pre-cooked and pre-processed food is anticipated to register substantial sales volume by the one doth year 2020 on the back of shelf-piling dry food concerns in the country and reversal of the production cycle.

Typically, a pre-cooked and pre-processed food item is packaged in a food grade container and then frozen to keep the food contents fresh for an extended time, the food item is shipped directly to customers, sold at grocery stores, convenience stores, other point of sale avenues or through vending machines and it's heated by the consumer before consuming.

However, where pre-cooked and pre-processed meals are considered a fast and convenient by preparing them by using a heating appliance, the food is most often never heated uniformly because of frozen or cold food pockets that are found under the top food layer that is un-exposed to heat source like conventional oven, microwave oven, etc. The above-mentioned reasons can lead to subpar customer experience as the customer has to re-heat the food after realizing its not heated uniformly or in many cases consume improper heated food. An improper heated food with cold pockets not only effects the taste of food but can also cause severe health concerns.

As far as understanding of heating phenomenon of microwave functionality is concerned, Microwaves are a form of “electromagnetic energy”, which means energy that travels through vacuum at the speed of light. It is constantly cycling its coupled electrical and magnetic fields back and forth in time (therefore the name electromagnetic). The distance over which it changes form is known as its “wavelength”. In an ocean wave we measure its strength by the wave's height, in light, by its electric or magnetic field strength. Microwaves are almost a million time longer in wavelength than UV light, and invisible to the naked eye. Like sunlight, they are absorbed by your skin, but they penetrate more deeply and the peaks-to-peaks are so broad (a few inches), they cannot tug strongly enough across the width of an atom to tear it apart.

According to Dr. Greg Blonder (an expert in superconductivity and the quantum phenomena of semiconductor materials who has been head of the Photonics and Electronics Research Department, and then in 1991 to director of the Materials and Technology Integration Research Laboratory. Dr. Blonder attended the Massachusetts Institute of Technology (M.I.T.) where his undergraduate thesis was on phase transitions in liquid crystals. In 1982 he received his MS and Ph.D. in Physics from Harvard University after explaining the physics behind the normal-superconducting transition and sub-harmonic energy gap in point contact junctions.) even perfectly homogeneous microwave would still not cook or heat food uniformly because of three fundamental reasons.

The first reason is amount of absorbed radiation depends on the food's electrical properties. Highly conductive foods (for example, salty meats, some sugars and oils, etc.) vigorously absorb microwaves. On the other hand, food which interacts poorly with microwaves (say dry bread with many air pockets, or ice, where the crystallized water molecules are so tightly packed, they cannot vibrate responsively to the microwaves' electric field), heats uniformly through and through, though less quickly. The second reason is thickness or depth of food. Thirdly the physical qualities of the container like thickness, material, depth and similar properties also matter.

The current invention resolves all these three fundamental problems to create a uniform food heating solution. There are multiple inventions that have been proposed art regarding brining an advancement and enhanced utility in similar domain and to solve above mentioned problem.

In U.S. Pat. No. 4,351,997 has been proposed previously provide a modified form of the structure of the tray to try to get a more uniform warming of the food item in the tray when exposed to radiation of the microwaves This prior art has the bottom wall of microwave transparent material and a peripheral wall that it extends upwards and is curved outward at its end upper forming a horizontal peripheral flange. The flange is partially or completely coated with a material that is reflective and opaque to microwave radiation, such as p. e.g., an aluminum foil. The peripheral wall is also partial or completely coated with the sheet material. The effect of this coating with an aluminum foil on the wall is the of providing the reflection of microwave energy towards the center of the tray.

U.S. Pat. No. 4,626,641 describes a version in which a similar structure is provided. In addition to the provision of an aluminum sheet on the side wall of a tray, the sheet also extends through the base of the container but leave a rectangular area open in the back wall.

WO 92/19511 refers to a tray useful for microwave cooking of a prepared food, the which comprises an outer layer formed of cardboard or plastic molded to which an inner layer of a sheet has been laminated polymeric A layer of microwave reflective material, normally an aluminum foil is placed between the layers outside and inside the peripheral wall of the tray, and in a model on a portion of the back wall.

JP 09-369450 patent is referring to a container for a microwave oven comprising a first microwave reflective plate placed along of a circular side part and a second reflective plate at microwave in the base section of the container.

U.S. Pat. No. 5,986,248 is a US patent which describes a food container for heating by microwave by an area covered with a reflective material to the microwaves This document describes that using said vessel is heated heating in the center of the block of food.

EP 511 507 A1 is a Patent Application European that describes a package that has a reflective layer at microwave. This allows to concentrate the microwaves and enhance the warming especially in the center of the food.

However the efficacy and practicality of above-mentioned systems is still questionable. The present invention thus aims to provide a superior solution for heating of a pre-cooked and pre-processed food in uniform manner using a heat appliance like conventional oven, microwave oven, air fryer, etc. and ensures the transfer of heat is unform across the food.

Furthermore, presently pre-cooked and pre-processed food like Ready To Eat frozen food is not heated uniformly as it is packaged in a flat horizontal tray that creates a thick food layer. The RTE food tray is placed horizontally on the circular rotation base inside a microwave, as micro waves do not come in contact of the flat horizontal tray in uniform fashion the food is not heated uniformly, this design flaw in a conventional microwave combined with the fact that the micro waves can only heat the food that it comes in contact with, the food on the top surface of the tray is only heated, leaving the food on the other side un treated with microwaves thus cold pockets are created and food thereof is not heated uniformly as shown in FIG. 9.

The present invention specially relates to a novel packaging method for pre-cooked and pre-processed food. It presents a novel approach of creating a cavity within the food body of food stored in a container with vertical walls instead of flat tray type container to achieve uniform heating and other various advantages which will be explained in later sections.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is a general object of the present invention to provide an improved form of assembly which relates to a technically a feasible process able solution to obtain a uniform heating of pre-cooked and pre-processed food using a heating appliance like a conventional oven, microwave oven, convection oven etc.

It is also the objective of the invention to provide a novel approach in developing the food placement and packaging method that creates a cavity within the food item that results in uniformly heating of the food contents by eliminating hard to heat solid fill food center core.

It is moreover the objective of the invention to provide a method where creation of a cavity in food body is done to push food on sides of container, to increase exposed surface area of food, to reduce total thickness of the food and create a consistent thinner food layer that is exposed uniformly to a heat source. As mentioned in article by Greg Blonder, total thickness of food is one of the main reasons for food not heating efficiently.

It is moreover the objective of the invention to provide a method where creation of a cavity in food body squeezes and displaces excess liquid (gravy, sauce) towards bottom of the container hence upon freezing the food, it creates less frozen liquid mass within the food. As mentioned in article by Greg Blonder, the ice interacts poorly to heating appliances such as microwaves, as the crystallized water molecules are so tightly packed, they cannot vibrate responsively to the microwaves' electric field), heats uniformly through and through, though less quickly.

More specifically, it is the principal object of this invention to provide an architecture which is cost efficient and where cavity promotes uniform and efficient heating without requiring a special food container or high-end microwave equipment like-microwave with wave guides, microwaves with multiple resonance modes etc.

It is also the objective of invention to promote health and safety where because of the uniform heating the chances of food borne illness is greatly reduced.

It is further the objective of invention to provide cavity which opens up the space to place a single or multiple small food grade container to hold various types of food articles which helps in keeping overall packaging size compact while still providing space for extras options to enhance overall food and customer experience without depending on external storage space.

It is also the basic objective of invention to create packaging of food in a tall vertical wall container with cavity instead of a typical flat tray container to greatly maximize food surface exposed to the heat source like conventional oven, microwave oven, etc. that results in achieving uniform food heating.

It is also the objective of invention to create packaging of food in a vertical wall container with cavity that creates uniform and effective heating as circular rotation of microwave base results in the food exposed to micro waves to a greater degree all around and evenly.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1—shows food item placed in a container in a conventional method that inherently creates a solid fill center core.

FIG. 2—shows an insert piece positioned towards body of the food, prior to creation of cavity.

FIG. 3—shows an insert piece that is pushed inside the body of the food to create an empty cavity as the food is pushed towards outer wall of the container.

FIG. 4—shows the insert piece removed from the body of food item after the cavity is formed.

FIG. 5—shows top view of the food container with the insert piece pushed in the food body.

FIG. 6—shows cross-sectional view of the food container with insert piece pushed into the food body.

FIG. 7—shows cross-sectional view of the food container with cavity within the food body after the insert piece is removed.

FIG. 8—shows cross-sectional view of the food container with multiple small food grade containers in the food cavity to store condiments etc.

FIG. 9—shows a flat style food tray container containing food as a popular and common food container and its utility limitations due to hard-to-heat center and/or deeper food layers that forms cold and/or frozen food pocket that results in un evenly cooked or heated food (this depicts the problem in current pre-cooked and pre-processed food placing and packaging method).

FIG. 10—shows cross-sectional view of the food container with a single small food grade container covering full or partial part of the cavity to store condiments etc.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide an advance solution for heating the food product typically stored in a food grade material packaging and provide a uniform approach toward heating of food product once placed in a conventional oven, microwave oven, deep fryer, etc.

The method comprises of pre-cooked and pre-processed food placement and packaging method that creates an open cavity within the food item prior to refrigerating or freezing stage that eliminates hard to heat solid fill food core when heated using a heating appliance like conventional oven, microwave oven, etc. resulting in uniformly heating of the food contents.

The proposed method as per its embodiments allows to create a cavity in the food body itself that is placed in food grade container comprising of container having a circular and upright wall. The method comprises of pushing an external object (insert piece device) into the food body to allow food to be pushed against the outer walls of the food container. Once desired proportion is achieved, the insert piece device is removed from the food body to form an open cavity in the food body. The cavity creates more open surface area of food exposed for better heat transfer and also reduces food thickness and removes the solid food fill that forms hard-to-heat cold pockets, so now when the food is heated by way of conduction, convection or radiation the heat transfer can reach the food to a greater degree to heat it uniformly and efficiently.

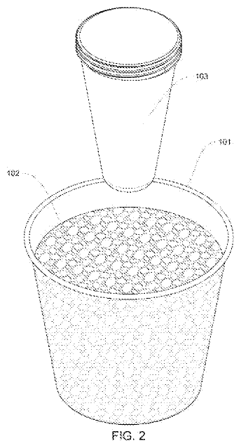

The insert piece as shown from FIG. 2-8 and FIG. 10 is developed from food grade material and non-edible material. The non-edible material may comprise of materials including but not limited to metal, polymer, ceramic, magnet metal and non-stick material.

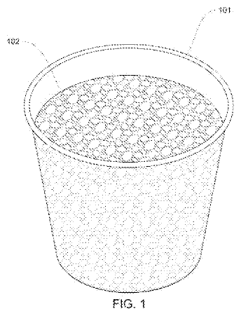

By looking at the attached drawings, the embodiments of proposed invention can be understood in detail. The FIG. 1 shows food item (102) is placed in a container (101) in a conventional method that inherently creates a solid fill core.

This is the most common approach in which food is filled and packed within the container.

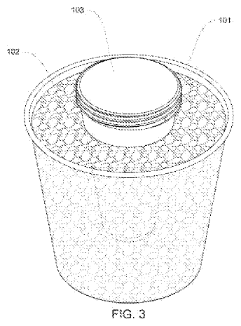

The FIG. 2 shows an insert piece (103) positioned towards body of the food container (101) containing food (102) prior to creation of cavity. The FIG. 3 shows an insert piece (103) that is pushed inside the food body (102) to create an empty cavity as the food is pushed towards outer wall of the container (101).

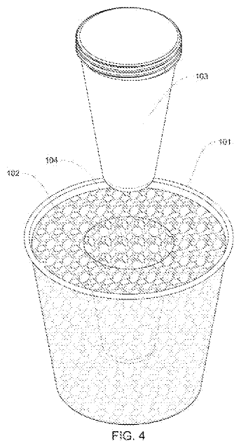

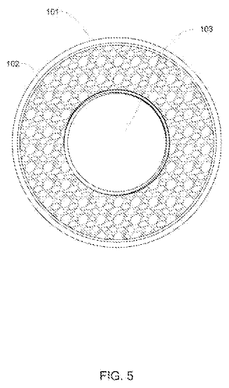

The FIG. 4 as per its further embodiments shows the insert piece (103) removed from the food body (102) item contained in the container (101) after the cavity (104) is formed. The FIG. 5 shows top view of the food container (101) with the insert piece (103) pushed into the food (102).

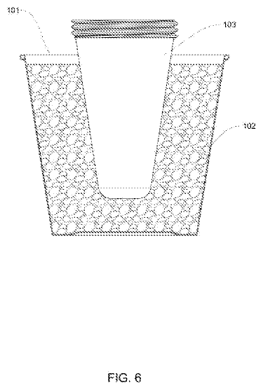

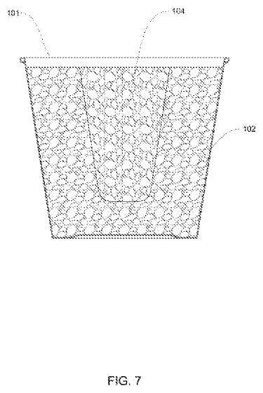

The FIG. 6 shows cross-sectional view of the food container (101) with insert piece (103) pushed inside the food body (102). The FIG. 7 shows the cross-sectional view of the food container (101) with cavity (104) within the food (102) after the insert piece (103) is removed.

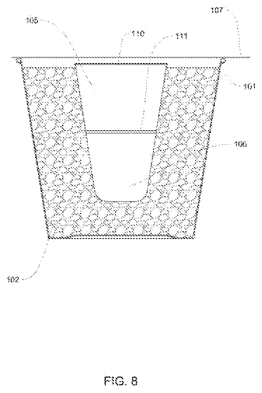

The FIG. 8 shows cross-sectional view of the food container (101) with multiple small food grade containers (105), (106) in the food cavity (104) to store condiments etc. The food (102) is pushed on sides for effective heating.

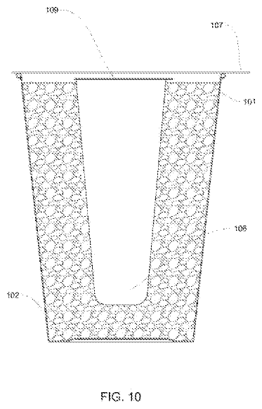

The FIG. 10 shows another cross-sectional view of the food container (101) with a single small food grade container covering full or partial part of the food cavity to store condiments (106) etc. with a lid (109) of small food container.

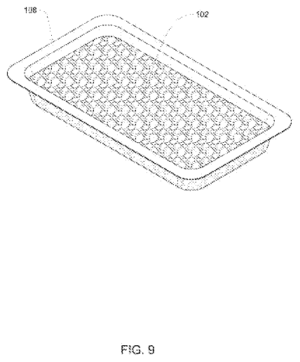

The FIG. 9 shows a typical flat style food tray container (108) containing food (102) as a popular and common food container and its utility limitations due to hard-to-heat center and/or deeper food layers that forms cold and/or frozen food pocket that results in un evenly cooked or heated food.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A method of forming a cavity within the body of pre-cooked and pre-processed food comprising of rice, pasta, beans, noodles, vegetables, meat, poultry, fish, seafood, eggs, dairy, oils, nuts, nut butter, spice, sauce, juice, marinades, thickening agents, emulsifiers, flavorings, enhancing agents, food colors, shelf life extending agents and any other edible ingredients:
method of claim 1, wherein an insert piece device is pushed down partially or completely in to body of said food placed in a food container comprising of container having upright circular side walls as shown in FIG. 3;
method of claim 1, wherein insert piece device is removed from the said food to create a cavity in said food;
method of claim 1, wherein the depth, width and shape of cavity is varied by the size and shape of insert piece device and container shape as per specific results required to achieve cavity size and shape, food thickness and food consistency for a certain type of recipe and method of preparation, ingredients, container shape, size, material, use etc.

2: An insert piece device as shown in FIG. 2, to create a cavity within the body of pre-cooked and pre-processed food is made of material comprising of food grade material:
The device as per claim 2, wherein the insert piece device is made of material comprising of non-food grade material;
The device as per claim 2, wherein the insert piece device is made of material comprising of a non-edible material, an edible material, a partially edible material, etc.;
The device as per claim 2, wherein the insert piece device is made of shape and size comprising of a varied shape and size to form a desired depth, width and shape of cavity in said food body;
The device as per claim 2, wherein the insert piece device is hollow, solid or a combination of both;
The device as per claim 2, wherein the insert piece device is made of material comprising of inflatable an expandable material;
The device as per claim 2, wherein the insert piece device is coated with material comprising of non-edible material as a layer;
The device as per claim 2, wherein the insert piece device's material comprises of a polymer, monomer, ceramic, glass, rubber, non-stick material, metal, magnetic metal;
The device as per claim 2, wherein insert piece device comprises at least 10 weights % of the nonedible material.

3: A method of achieving efficient and uniform heating of pre-cooked and pre-processed food by pushing insert piece device to create cavity prior to refrigerating or freezing of food package comprising of rice, pasta, beans, noodles, vegetables, meat, poultry, fish, seafood, eggs, dairy, oils, nuts, nut butter, spice, sauce, juice, marinades, thickening agents, emulsifiers, flavorings, enhancing agents, food colors, shelf life extending agents and any other edible ingredients:
process of claim 3, wherein creation of cavity in said food increases exposed surface area of said food resulting in increased heat transfer via a heating appliance comprising of conventional oven, microwave oven, convection oven, air fryer, skillet, deep fryer etc.;
process of claim 3, wherein creation of cavity in said food reduces total thickness of said food, thereby increasing efficiency to heat said food via a heat source comprising of conventional oven, microwave, convection oven, air fryer, skillet, deep fryer etc.;
process of claim 3, wherein creation of cavity in said food eliminates solid food fill that forms hard-to-heat cold pockets due to being unexposed to a heat source comprising of conventional oven, microwave, convection oven, air flyer, skillet, deep fryer etc.;
process of claim 3, wherein insert piece device is pushed down in to body of said food to create cavity exerts pressure to push said food against outer side walls and base of the container henceforth squeezing said food to displace liquid ingredient towards bottom of the container, thereby upon freezing said food results in reduction of crystalized water molecules in food against container walls, hence making said more conductive in nature to increase heating efficiency by use of a heat source comprising of conventional oven, microwave, convection oven, air fryer, skillet, deep fryer etc.;
process of claim 3, wherein the insert piece device is pushed in the body of said food allows food stuff to push further towards the outer walls of food container resulting in rising the food level on the container wall, allowing more food to be exposed directly to heat source comprising of conventional oven, microwave, convection oven, air flyer, skillet, deep flyer etc. thus resulting in increased, efficient and uniform heating;
process of claim 3, wherein the insert piece device is pushed in and then removed from the body of said food prior to freezing stage, increases exposed food area to multiple heat sources, eliminates frozen food pocket and create a hollow space to reduce the total food thickness, the said food is pressed towards outer container walls causing reduction in frozen crystalized water molecules from the food body and rising of the food level in the container to increase food exposure to heat source, all these improvements have a much higher synergetic effect on end results when said food is heated resulting in increased, efficient and uniform heating.

4: Invention of open cavity within food body to enhance customer experience by allowing to add any extra food materials per personal liking comprising of seasoning, condiment, etc.:
Invention of claim 4, wherein a cavity gives easy access to the bottom and middle part of the food using an eating device like spoon to mix all food ingredients evenly prior to consuming of said food;
Invention of claim 4, wherein a cavity gives easy access to place an eating device like a spoon, fork, chopstick etc. made from food grade materiel to be used by the customer;
Invention of claim 4, wherein a cavity gives easy access to customer to place a single or multiple small food grade container/s to use as a storage for personal, food or health related item including but not limited to medicines taken at time of food for certain health conditions like diabetes, heartburn etc., coffee pods, food flavorings, surprise gift, paper not, etc.;
Invention of claim 4, wherein a cavity gives easy access to a manufacturer to strategically place a single or multiple small food grade container/s depending on meal type and customer demographic to store a general item comprising of condiments, dips, chewable multivitamin pill, a breath freshener item like a chewing gum, a cross word puzzle, a small dessert item like ice cream, fortune cookie, etc.;
Invention of claim 4, wherein a cavity gives easy access to a manufacturer to strategically place a single or multiple ice pack to keep food cold or frozen for extended time;
Invention of claim 4, wherein a cavity formation in pre-cooked and pre-processed food to attain uniform and efficient heating by using a standard conventional oven, microwave oven, etc. with minimum functionalities and not requiring a special, technologically advanced or high-power heating appliance like conventional oven, microwave oven, etc.;
Invention of claim 4, wherein a cavity formation in pre-cooked and pre-processed food to attain uniform heating method reduces the chances of food borne illness due to improper heating of cold or frozen food.
